(19) United States
(12) Patent Application Publication
(10) Pub. No.: US 2017/0255877 A1
(43) Pub. Date: Sep. 7, 2017

(54) HETEROGENEOUS COMPUTING METHOD

(71) Applicant: ELECTRONICS AND TELECOMMUNICATIONS RESEARCH INSTITUTE, Daejeon (KR)

(72) Inventors: Hyunwoo CHO, Sejong (KR); Do Hyung KIM, Daejeon (KR); Cheol RYU, Daejeon (KR); Seok Jin YOON, Daejeon (KR); Jae Ho LEE, Daejeon (KR); Hyung-Seok LEE, Daejeon (KR); Kyung Hee LEE, Daejeon (KR)

(21) Appl. No.: 15/167,861

(22) Filed: May 27, 2016

(30) Foreign Application Priority Data
Mar. 2, 2016 (KR) 10-2016-0025212

(51) Int. Cl. G06N 99/00

(52) U.S. Cl. CPC G06N 99/005

(57) ABSTRACT

There is provided a heterogeneous computing method. A heterogeneous computing method includes performing offline learning on an algorithm using compilations and runtimes of application programs, executing a first application program in a mobile device, distributing a workload to a central processing unit (CPU) and a graphic processing unit (GPU) in the first application program, using the algorithm, performing online learning to reset the workload distributed to the CPU and GPU in the first application program, and resetting the workload distributed to the CPU and GPU in the first application program, corresponding to a result of the online learning.

### CROSS-REFERENCE TO RELATED APPLICATION

This application claims priority to and the benefit of Korean Patent Application No. 10-2016-0025212, filed on Mar. 2, 2016, in the Korean Intellectual Property Office, the entire contents of which are incorporated herein by reference in their entirety.

### BACKGROUND

1. Field

An aspect of the present disclosure relates to a heterogeneous computing method, and more particularly, to a heterogeneous computing method capable of effectively distributing a workload through offline and online learning.

2. Description of the Related Art

Heterogeneous computing refers to dividing a work operation processed by a central processing unit (CPU) and processing the work operation together with a graphic processing unit (GPU). Although the GPU is specialized to perform graphics processing, the GPU can be in charge of a portion of a work operation performed by the CPU with the development of up-to-date technologies (e.g., a general-purpose computing on graphics processing unit (GPGPU)).

The CPU includes at least one core optimized in serial processing and thus can process sequential work operations at fast processing speed. On the other hand, the GPU includes a hundred or more cores and thus is suitable to perform parallel processing on a single work operation.

### SUMMARY

Embodiments provide a heterogeneous computing method capable of effectively distributing a workload through offline and online learning.

According to an aspect of the present disclosure, there is provided a heterogeneous computing method including: performing offline learning on an algorithm using compilations and runtimes of application programs; executing a first application program in a mobile device; distributing a workload to a central processing unit (CPU) and a graphic processing unit (GPU) in the first application program, using the algorithm; performing online learning to reset the workload distributed to the CPU and GPU in the first application program; and resetting the workload distributed to the CPU and GPU in the first application program, corresponding to a result of the online learning.

The application programs and the first application program may be written with a web computing language (WebCL).

The heterogeneous computing method may further include: after the online learning is ended, ending a current routine of the first application program and returning a state value; setting a start point of the first application program using the ended current routine and the state value; distributing a workload to the CPU and GPU, corresponding to the online learning; and executing the first application program from the start point.

The online learning may be performed at a background.

The performing of the offline learning may include: extracting a feature value from each of the compilations of the application programs; analyzing the runtimes of the application programs while changing a workload ratio of the CPU and GPU; and performing learning of the algorithm, corresponding to the extracted feature value and a result obtained by analyzing the runtimes.

The feature value may include at least one of a number of times of memory access, a number of floating point operations, a number of times of data transition between the CPU and GPU, and a size of a repeating loop.

The algorithm may distribute a workload to the CPU and GPU using a feature value extracted from a compilation of the first application program.

The feature value may include at least one of a number of times of memory access, a number of floating point operations, a number of times of data transition between the CPU and GPU, and a size of a repeating loop.

The performing of the online learning may include: a first process of determining whether performance is in a saturation state while changing the number of work items per core; a second process of, when the performance is improved in the first process, repeating the first process while changing the workload ratio of the CPU and the GPU; and a third process of, when the performance is not improved in the first process, ending the online learning.

The point of time when it is determined that the performance has been in the saturation state may be a point of time when the execution time of the first application program is shortened within a preset critical time when the number of work items per core is increased.

The number of work items assigned per core may be linearly increased.

The number of work items assigned per core may be exponentially increased.

The performance may be determined using the execution speed of the first application program.

### BRIEF DESCRIPTION OF THE DRAWINGS

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the example embodiments to those skilled in the art.

In the drawing figures, dimensions may be exaggerated for clarity of illustration. It will be understood that when an element is referred to as being “between” two elements, it can be the only element between the two elements, or one or more intervening elements may also be present. Like reference numerals refer to like elements throughout.

FIG. 1 is a flowchart illustrating an offline learning method according to an embodiment of the present disclosure.

FIG. 2 is a flowchart illustrating a process of distributing a workload in a heterogeneous computing environment according to an embodiment of the present disclosure.

FIG. 3 is a flowchart illustrating a method for performing online learning according to an embodiment of the present disclosure.

### DETAILED DESCRIPTION

In the following detailed description, only certain exemplary embodiments of the present disclosure have been shown and described, simply by way of illustration. As those skilled in the art would realize, the described embodiments may be modified in various different ways, all without departing from the spirit or scope of the present disclosure. Accordingly, the drawings and description are to be regarded as illustrative in nature and not restrictive.

As new mobile devices are released at a high speed, it is gradually difficult to ensure the compatibility of programs. For example, a first application program developed based on a specific mobile device may not be normally executed in other mobile devices except the specific mobile device.

Considerable effort and time are required to allow the first application program to be executed in other mobile devices except the specific mobile device. Practically, a work operation for the compatibility of the first application program may require more effort and time than the development of the first application program.

Meanwhile, an application program executed in a web browser complying with an HTML5 standard is executed regardless of the end of a mobile device. Since real-time debugging that hardly requires compilation is possible in the web browser, productivity can be improved by reducing a debugging time. Recent mobile devices are equipped with high-performance CPUs and GPUs, and hence the speed of the web browser, and the like are increased. Accordingly, it is highly likely that application programs based on the web browser will be applied.

Meanwhile, a web computing language (WebCL) based on an open computing language (OpenCL) has been standardized as a parallel processing language for large-scale operation by the Khronos Group. The WebCL is a heterogeneous computing parallel processing language, and enables not only CPUs but also GPUs to be used as operation devices. Furthermore, the WebCL supports heterogeneous computing devices such as a field-programmable gate array (FPGA), and a digital signal processor (DSP).

When a work operation of an application program is processed, advantages/disadvantages of the CPU and GPU are very obvious. When operation processing is frequently repeated, it is advantageous that cores of the GPU perform parallel processing on different data areas and then output a result. On the other hand, when there are many sequential work operations (i.e., when a result of a previous work operation is required as an input of a next work operation), it is advantageous to use a fast processing speed of the CPU. However, in addition, the distribution of a workload is influenced by various factors including a work operation assigned per core, a number of times of memory access, a number of times of data transmission between the CPU and GPU, and the like.

Currently, a programmer develops (i.e., codes) an application program such that a workload between the CPU and GPU is distributed by reflecting various factors. However, the workload distributed by the programmer does not reflect characteristics of respective mobile devices. When an application is developed such that the characteristics of the respective mobile devices are reflected, much time is additionally required, and hence it is difficult to highlight advantages of the web browser. Accordingly, it is required to develop a heterogeneous computing method capable of effectively distributing a workload.

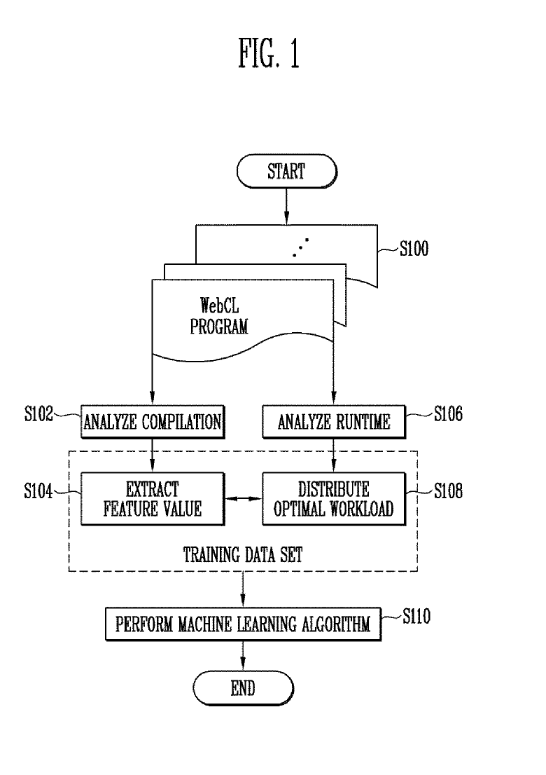

FIG. 1 is a flowchart illustrating an offline learning method according to an embodiment of the present disclosure.

The offline learning method according to the embodiment of the present disclosure will be described as follows with reference to FIG. 1. A mobile device used in offline learning may include a CPU and a GPU, which are widely used.

### <Preparing of WebCL Program: S100>

First, a plurality of application programs written with the WebCL are prepared. The application programs prepared in step S100 are used for the learning of an algorithm, and may be variously prepared corresponding to usage rates of the CPU and GPU. For example, in step S100, there may be prepared application programs having a high usage rate of the CPU, application programs having a high usage rate of the GPU, and application programs having similar usage rates of the CPU and GPU.

### <Analyzing of Compilation & Extraction of Feature Value: S102, S104>

After that, a compilation of each of the application programs prepared in step S100 is analyzed, thereby extracting a feature value. Here, the feature value refers to a value required to distribute a workload to the CPU and GPU. For example, the feature value may include at least one of a number of times of memory access, a number of floating point operations, a number of times of data transition between the CPU and GPU, and a size of a repeating loop.

### <Analyzing of Runtime & Distributing of Optimal Workload: S106, S108>

While each of the application programs prepared in step S100 is being executed, an optimal workload to be distributed is determined. For example, a workload distributed to the CPU and GPU may be determined such that the maximum performance is achieved while a workload assigned to the CPU and GPU is being changed when the application program is executed.

Meanwhile, a workload distributed to the CPU and GPU, which corresponds to the analysis of the compilations, can be obtained through steps S100 to S108. That is, an actual optimal workload to be distributed to the CPU and GPU can be obtained corresponding to the feature values extracted in the compilations.

### <Performing of Machine Learning Algorithm: S110>

The feature values extracted in step S104 and the optimal workload distributed to the CPU and GPU, which is determined in step S108, are used as a training data set of the an algorithm. In other words, the learning of the algorithm is performed using the feature values extracted in step S104 and the optimal workload to be distributed to the CPU and GPU, which is determined in step S108.

Specifically, application programs are continuously created, and hence it is substantially impossible to analyze runtimes corresponding to compilations of all application programs. Accordingly, in the present disclosure, the learning of the algorithm is performed using the feature values extracted in step S104 and the optimal workload to be distributed to the CPU and GPU, which is determined in step S108. The learned algorithm can distribute a workload to the CPU and GPU using the feature values extracted from the compilations of the application programs.

That is, in the present disclosure, the learning of an algorithm is performed in an offline manner, and accordingly, a workload can be distributed to the CPU and GPU using the algorithm.

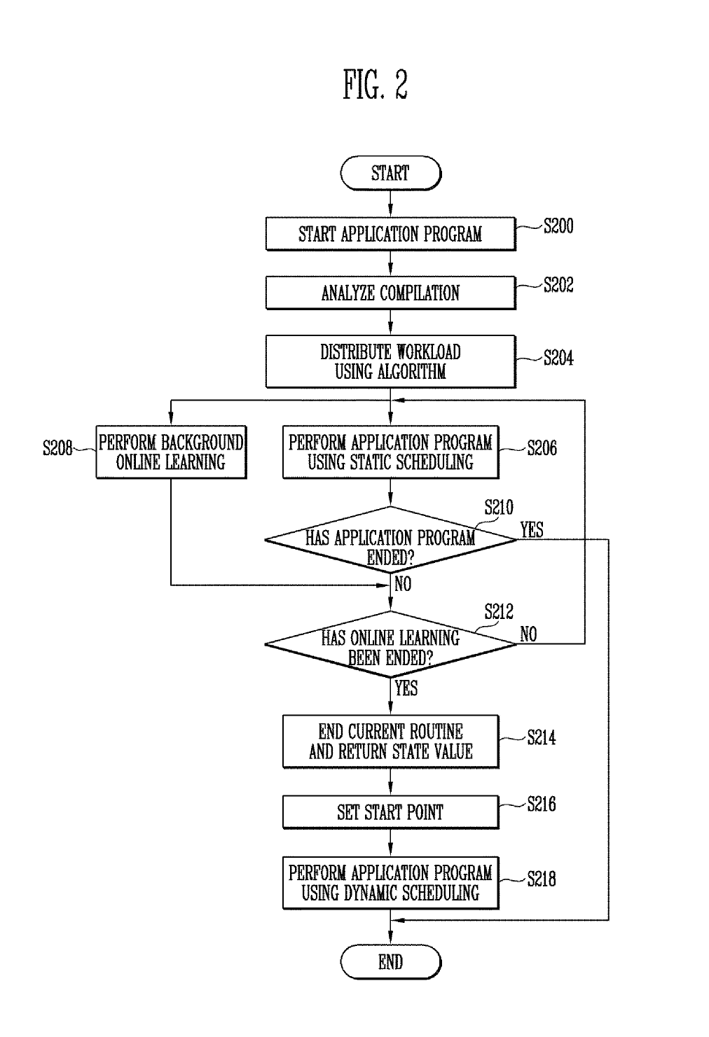

FIG. 2 is a flowchart illustrating a process of distributing a workload in a heterogeneous computing environment according to an embodiment of the present disclosure.

The process according to the embodiment of the present disclosure will be described as follows with reference to FIG. 2.

### <Starting of Application Program: S200>

First, an algorithm learned in an offline manner is installed in a specific mobile device. The algorithm may be installed in the form of a separate program in the specific mobile device. Hereinafter, for convenience of illustration, a program including an algorithm will be referred to as a distribution program. An application program written with the WebCL is executed in the specific mobile device in which the distribution program is installed.

### <Analyzing of Compilation & Distributing of Workload: S202, S204>

After the application program is started, the distribution program analyzes a compilation of the application program, thereby extracting a feature value. Here, the feature value may include at least one of a number of times of memory access, a number of floating point operations, a number of times of data transition between the CPU and GPU, and a size of a repeating loop. After the feature value is extracted, the algorithm distributes a workload for each of the CPU and GPU, corresponding to the feature value.

In step S204, the workload distributed by the algorithm is mechanically determined corresponding to offline learning. Additionally, the algorithm (i.e., the distribution program) installed in the specific mobile device may be continuously updated, and accordingly, the accuracy of the workload distributed in step S204 can be improved.

### <Performing of Application Program: S206>

After the workload is distributed in step S204, the application program is executed. Meanwhile, the application program is performed using static scheduling, corresponding the workload distributed to the CPU and GPU in step S204, and accordingly, the workload distributed to the CPU and GPU, which is determined in step S204, is not changed.

### <Performing of Background Online Learning: S208>

While the application program is being executed, the distribution program performs online learning for allowing the application program to change the workload distributed to the CPU and GPU.

Specifically, the workload distributed using the algorithm in step S204 is mechanically distributed, and does not reflects characteristics of the device in which the application program is executed.

For example, the algorithm performs offline learning using CPUs and GPUs, which are widely used, and hence does not reflect characteristics of a CPU and a GPU, which are included in a specific mobile device in which an application program is executed. Thus, in the present disclosure, the online learning is performed to reflect characteristics of hardware of the specific mobile device, and accordingly, the workload distributed to the CPU and GPU can be set to have an optimal state. Also, the number of work items per core is set to have an optimal state through the online learning, and accordingly, the execution speed of the application program can be improved.

Additionally, a result processed in the GPU is finally reflected in a web browser by the CPU, and hence the speed of an interface (e.g., a PCI-e) between the CPU and GPU has great influence on the speed of the application program. Since it is difficult to perform modeling on the speed of the interface, the characteristics of the specific mobile device are reflected using the online learning. A method for performing the online learning in step S208 will be described in detail later.

Meanwhile, the application program is to be stably executed even when the online learning is performed. Therefore, the online learning is performed at a background.

### <Ending of Application Program: S210>

In step S210, it is determined whether the application program is to be ended. When the application program is ended in step S210, the online learning is also ended. In this case, the application program executed or ended corresponding to the workload distributed in step S204.

### <Ending of Online Learning: S212>

When the application program is not ended in step S210, the distribution program determines whether the online learning has been ended. If the online learning is not ended, the online learning is continuously performed (repeating of steps S206 to S212).

### <Ending of Current Routine & Returning of State Value: S214>

If it is determined that the online learning has been ended in step S212, a current routine is ended, and simultaneously, a state value is returned. To this end, the distribution program includes a process of tracking a runtime operation of the application program.

### <Setting of Starting Point: S216>

After that, the distribution program sets a start point of the application program using the routine ended in step S214, the state value, etc. For example, the ended routine may be set to the start point.

### <Performing of Application Program Using Dynamic Scheduling: S218>

After that, the distribution program resets a workload ratio of the CPU and GPU and a number of work items per core, corresponding to a result of the online learning. Then, the distribution program re-performs the application program from the start point using dynamic scheduling by reflecting the reset result. Additionally, the result of the online learning is stored in a memory, etc. of the specific mobile device. After that, a workload (including usage rates of the CPU and GPU, a number of work items per core, etc.) of the application program is determined by reflecting the result of the online learning when the application program is executed.

That is, in the present disclosure, when the application program written with the WebCL is executed in the specific mobile device, the online learning is performed at least once, thereby storing a result. Further, a workload is distributed using the result stored by performing the online learning when the application program is executed, so that it is possible to ensure optimal performance.

As described above, in the present disclosure, the learning of an algorithm is performed in the offline manner, and, when an application program is executed, a workload is assigned to the CPU and GPU using the algorithm. In this case, the workload is automatically assigned to the CPU and GPU using the algorithm, and hence the execution performance of the application program can be ensured to a certain degree.

Additionally, in the present disclosure, the workload distributed to the CPU and GPU is reset such that characteristics of hardware of a specific mobile device are reflected using online learning while an application program is being executed, so that it is possible to optimize the execution performance of the application program.

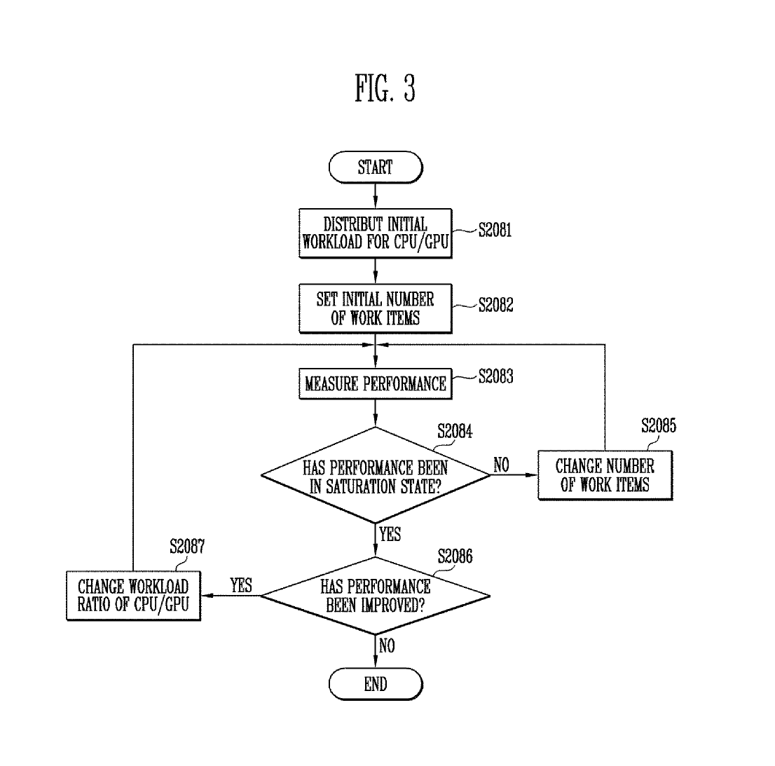

FIG. 3 is a flowchart illustrating a method for performing the online learning according to an embodiment of the present disclosure.

The method according to the embodiment of the present disclosure will be described as follows with reference to FIG. 3.

### <Distributing of Initial Workload for CPU/GPU: S2081>

After the application program is executed in the specific mobile device, a workload is distributed to the CPU and GPU by the algorithm. That is, the algorithm described in step S204 distributes the workload for each of the CPU and GPU using the feature value extracted from the compilation of the application program.

### <Setting of Initial Number of Work Items: S2082>

After the workload is distributed to the CPU and GPU, work items per core are assigned. For example, one work item per core may be assigned at an initial stage.

### <Measuring of Performance: S2083>

After that, the distribution program measures performance of the application program using the workload distributed for each of the CPU and GPU in step 2081 and the work item assigned per core. For example, the distribution program may measure the performance using an execution time of the application program, etc.

### <Saturation State of Performance: S2084>

After the performance of the application program is measured, the distribution program determines whether the performance measured in step S2083 is in a saturation state. A detailed description related to this will be described in step S2085.

### <Changing of Number of Work Items: S2085>

When it is not determined in step S2084 that the performance is in the saturation state, the distribution program changes the number of work items assigned per core. For example, the distribution program may assign two work items per core.

Specifically, the distribution program repeats steps S2083, S2084, and S2085 at least twice. In steps S2083 to S2085, the distribution program measures an execution time of the application program while changing the number of work items per core.

Generally, if the number of work items per core is increased, the execution time of the application program is shortened. In addition, if the number of work items per core is assigned to a certain degree or more, the execution time of the application program is constantly maintained to a certain degree regardless of an increase in the number of work items per core. To this end, in the present disclosure, a critical time is previously set, and it may be determined that the performance has been saturated when the execution time of the first application program is shortened within the critical time when the number of work items per core is increased. Additionally, the critical time may be experimentally determined by considering characteristics of various mobile devices.

Meanwhile, the number of work items assigned per core in step S2085 may be linearly increased. Also, the number of work items assigned per core in step S2085 may be exponentially increased. When the number of work items assigned per core is linearly increased, the point of time when the performance is saturated can be accurately detected. When the number of work items assigned per core is exponentially increased, the time assigned in steps S2083 to S2085 can be minimized.

### <Improving of Performance: S2086>

When it is determined in step S2084 that the performance has been in the saturation state, the distribution program determines whether the performance has been improved as compared with the previous performance. For example, after the workload ratio of the CPU and GPU and the number of work items per core are changed, the distribution program may determine whether the performance has been improved by comparing an execution speed of the application program with the previous execution speed (before the workload ratio is changed).

### <Changing of Workload Ratio of CPU/GPU: S2087>

When it is determined in step S2086 that the performance has been improved, the usage rates of the CPU and GPU are changed. After that, the number of work items per core and the usage rates of the CPU and GPU may be changed to be in an optimal state while repeating steps S2083 to S2087.

Additionally, when it is determined in step S2086 that the performance has been not improved, the online learning is ended.

After that, the usage rates of the CPU and GPU, the number of work items per core, etc., which are determined through the online learning in steps S212 to S218, are reflected, and accordingly, the execution speed of the application program can be improved.

According to the heterogeneous computing method of the present disclosure, the learning of an algorithm is performed in an offline manner, and the learned algorithm distributes a workload to a CPU and a GPU when an application program is executed in a mobile device. After that, the workload distributed to the CPU and GPU and the number of work items assigned per core are reset through online learning while the application program is being executed. Then, the application program is executed in the mobile device by reflecting a result of the online learning. Accordingly, in the present disclosure, it is possible to optimally set usage rates of the CPU and GPU in the application program through the offline learning and the online learning.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present disclosure as set forth in the following claims.

What is claimed is:

1. A heterogeneous computing method comprising:
performing offline learning on an algorithm using compilations and runtimes of application programs;
executing a first application program in a mobile device;
distributing a workload to a central processing unit (CPU) and a graphic processing unit (GPU) in the first application program, using the algorithm;
performing online learning to reset the workload distributed to the CPU and GPU in the first application program; and
resetting the workload distributed to the CPU and GPU in the first application program, corresponding to a result of the online learning.

2. The heterogeneous computing method of claim 1, wherein the application programs and the first application program are written with a web computing language (WebCL).

3. The heterogeneous computing method of claim 1, further comprising: after the online learning is ended,
ending a current routine of the first application program and returning a state value;
setting a start point of the first application program using the ended current routine and the state value;
distributing a workload to the CPU and GPU, corresponding to the online learning; and
executing the first application program from the start point.

4. The heterogeneous computing method of claim 1, wherein the online learning is performed at a background.

5. The heterogeneous computing method of claim 1, wherein the performing of the offline learning includes:
extracting a feature value from each of the compilations of the application programs;
analyzing the runtimes of the application programs while changing a workload ratio of the CPU and GPU; and
performing learning of the algorithm, corresponding to the extracted feature value and a result obtained by analyzing the runtimes.

6. The heterogeneous computing method of claim 5, wherein the feature value includes at least one of a number of times of memory access, a number of floating point operations, a number of times of data transition between the CPU and GPU, and a size of a repeating loop.

7. The heterogeneous computing method of claim 1, wherein the algorithm distributes a workload to the CPU and GPU using a feature value extracted from a compilation of the first application program.

8. The heterogeneous computing method of claim 7, wherein the feature value includes at least one of a number of times of memory access, a number of floating point operations, a number of times of data transition between the CPU and GPU, and a size of a repeating loop.

9. The heterogeneous computing method of claim 1, wherein the performing of the online learning includes:
a first process of determining whether performance is in a saturation state while changing the number of work items per core;
a second process of, when the performance is improved in the first process, repeating the first process while changing the workload ratio of the CPU and the GPU; and
a third process of, when the performance is not improved in the first process, ending the online learning.

10. The heterogeneous computing method of claim 9, wherein the point of time when it is determined that the performance has been in the saturation state is a point of time when the execution time of the first application program is shortened within a preset critical time when the number of work items per core is increased.

11. The heterogeneous computing method of claim 9, wherein the number of work items assigned per core is linearly increased.

12. The heterogeneous computing method of claim 9, wherein the number of work items assigned per core is exponentially increased.

13. The heterogeneous computing method of claim 9, wherein the performance is determined using the execution speed of the first application program.
